(19) United States
(12) Patent Application Publication
(10) Pub. No.: US 2021/0224644 A1
(43) Pub. Date: Jul. 22, 2021

(54) ARTIFICIAL INTELLIGENCE-DRIVEN METHOD AND SYSTEM FOR SIMPLIFIED SOFTWARE DEPLOYMENTS

(71) Applicant: SAP SE, Walldorf (DE)

(72) Inventors: Suchit Mathur, Bangalore (IN); Indu Venugopal, Bangalore (IN)

(21) Appl. No.: 16/862,088

(22) Filed: Apr. 29, 2020

(30) Foreign Application Priority Data
Jan. 22, 2020 (IN) 202011002758

(51) Int. Cl. G06N 3/08; G06N 20/00; G06K 9/62

(52) U.S. Cl. CPC G06N 3/08; G06K 9/6262; G06N 20/00

(57) ABSTRACT

The present disclosure relates to computer-implemented methods, software, and systems for automated process execution. A neural network including machine learning rules encoded at a rules engine is trained to synthesize input and to generate output for automated execution of processes at a platform landscape of a platform environment. The neural network is configured to convert the received input requesting a process execution into a sequence of executable work units based on the machine learning rules. A first input is received that defines a request in a natural language format. The first input is synthesized based on the machine learning rules at the neural network to generate a first sequence of actions corresponding to the request. The first sequence of actions is generated based on an evaluation of the first input in relation to keywords, parameter names, and parameter values. The generated sequence of actions is provided for automated execution.

### CLAIM OF PRIORITY

This application claims priority under 35 USC § 119(e) to Indian Patent Application No. 202011002758, filed on Jan. 22, 2020 the entire contents of which are hereby incorporated by reference.

### TECHNICAL FIELD

The present disclosure relates to computer-implemented methods, software, and systems for data processing in a platform environment.

### BACKGROUND

Software applications may execute processes in relation to providing user-requested services. Automation of process executions supports complex time-consuming activities that may have repetitive character and may be tedious for manual execution. In enterprise software deployment scenarios, a platform landscape includes different software applications and services that are distributed across multiple nodes or tenants or physical machines. When a new version of a software application is released, the complete landscape may need to be upgraded. Complexity is introduced in the deployments if there are additional configurations for security and authentications. With cloud computing, and especially with the Software-as-a-Service (SaaS) form of cloud computing, the complexity of managing expensive hardware and software at premise is eliminated, above and beyond the internal resources. Also, executing processes at landscapes including both cloud and on-premise solutions is a complex task.

### SUMMARY

The present disclosure involves systems, software, and computer implemented methods for automated execution of processes at an enterprise platform landscape where multiple software applications are running at one or more hardware instances.

Frequency of new software upgrades and updates, as well as the need to have different staging landscapes for testing and production scenarios may be supported by automation of multiple deployment operations at a corresponding landscape as requested by a user.

The solution described herein emphasizes incorporating the strengths of artificial intelligence (AI) in the automation space for software deployments and testing. In some instances, combining techniques of robotic process automation (RPA) along with machine learning (ML) techniques and cognitive intelligence provides a suitable approach for executions in simplified manner, with fewer resources spend and encompassing a large scale on-demand and cloud enterprise applications and platform environments.

One example method may include operations such as training a neural network including machine learning rules encoded at a rules engine to synthesize received input and to generate output for automated execution of processes at one or more platform landscapes of a platform environment, wherein the neural network is configured to convert the received input requesting a process execution into a sequence of executable work units based on the machine learning rules; receiving a first input defining a request in a natural language format, wherein the request is associated with a process execution at the platform environment; synthesizing the first input based on the machine learning rules at the neural network to generate a first sequence of actions corresponding to the request, wherein the first sequence of actions is generated based on an evaluation of the first input in relation to keywords, parameter names, and parameter values; and providing the generated sequence of actions for automated execution by a process automation framework at the platform environment. Other implementations of this aspect include corresponding systems, apparatus, and computer programs, configured to perform the actions of the methods, encoded on computer storage devices.

Implementations can optionally include that the keywords, parameter names, and parameter values are encoded in the machine learning rules, and wherein received input at the neural network is evaluated based on a mapping of identified natural words to one or more of a keyword, parameter name, and a parameter value.

In some instances, synthesizing the first input includes parsing the first input to identify keywords, parameter names, and parameter values; and identifying a work unit for execution at a first platform landscape at the platform environment based on a keyword from the identified keywords.

In some instances, a work unit corresponding to an action from the first sequence comprises work unit requirements for execution, the work unit requirements being identified based on the identified keyword associated with the work unit and other keywords from the keywords and the machine learning rules encoded in the rules engine.

In some instances, synthesizing the first input comprises generating the first sequence of actions and identifying corresponding work units including code and instructions for execution at a first platform landscape, wherein a first action is identified to map to a first keyword and one or more parameter values included in the first input.

In some instances, a first work unit is identified for the first action defined for the first keyword, and wherein a second work unit of the identified work units is identified to be related to the first work unit.

Some implementations can optionally include receiving, at the process automation framework, a sequence of instructions for execution at a first platform landscape at the platform environment, wherein the instructions correspond to the identified work units.

Some implementations can optionally include receiving second input comprising tracking information for consumption of monitored components at a first platform landscape at the platform environment; and validating the first sequence of actions and corresponding work units generated for the received first input based on the received second input, wherein the first sequence of actions defines an end-to-end workflow for execution at the components at the first platform landscape.

In some instances, a rule from the machine learning rules identifies an association between different keywords.

In some instances, the first input is in form of a text or voice input from a client application, wherein the first input include a plurality of words, wherein one or more first words of the first input correspond to a first work unit, and one or more second words of the first input correspond to a second work unit, wherein the first and the second work units are associated with a process for execution at a first platform landscape of the platform landscape, wherein the first platform landscape is identified by a first keyword corresponding to the first work unit.

It can be appreciated that the described instances of the present disclosure can be combined in different variations to cover two or more different aspects from different instances in one implementation.

Similar operations and processes may be performed in a system comprising at least one process and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. In other words, while generally described as computer implemented software embodied on tangible, non-transitory media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example computer system architecture that can be used to execute implementations of the present disclosure.

FIG. 2 is a block diagram for an example system for automated execution of processes at a platform environment in accordance with implementations of the present disclosure.

FIG. 3 is a flowchart for an example method for automated execution of processes at a platform environment in accordance with implementations of the present disclosure.

FIG. 4 is a schematic illustration of example computer systems that can be used to execute implementations of the present disclosure.

### DETAILED DESCRIPTION

The present disclosure describes various tools and techniques for automated execution of processes in a platform environment based on implementing machine learning techniques to support the process definition and execution.

For example, when a new version of a software application is released, the complete landscape, or a portion thereof, where the application is running may have to be upgraded. The deployment may be a complex process if there are additional configurations for security and authentications that have to be taken care of Frequency of new software upgrades and updates, as well as the need to have different landscapes for different client account or different development phases put together, provide business cases for automating the matrix of deployment combinations.

In some instances, an automation framework may be provided to support automated execution of processes at different software landscapes. The automation framework may support deployment and testing of software application that has to adapt to changing requirements related to the underlying technologies and platform environments.

In the realm of artificial intelligence and machine learning, users are provided with insight and information that may facilitate performing of actions at complex enterprise environments. However, some effort from users is still needed to achieve those along with maintaining required data protection of the underlying systems. This is due to multiple complexities of enterprise landscapes that require some manual effort to achieve desired results.

In some instances, a cloud application has to connect with solutions on different cloud platforms, regions, or applications to form complex deployments that require significant manual effort for setting up and validation after every release. In an on-premise multi-tier application, a deployment process may be executed across different tiers of client, web, and processing servers. A customer organization may deploy the enterprise software based on their niche tailored requirements. Additional layers may be configured for the authentication and security purposes. With a release of new software version including support packages and patches, a deployment of the new software version may be required each time on multiple machines. An end-to end thorough testing of the integrated landscape is critical to avoid production breakage.

In a cloud multi-tenant architecture, hyper scalars are reliable for a highly efficient, horizontally scalable distributed system, and can support more customers on fewer nodes. It also supports micro-service architecture, as an entire set of users can be provided with updates in one action. In the cloud scenarios, intervention is mostly required in cases where there is a specific type of authentication supported, database changes, or when the frequency of build updates demands frequent quality check with validation scenarios. A hybrid cloud deployment is a cloud computing environment that uses a mix of on-premises, private cloud, and third-party public cloud services with orchestration between the two platforms.

In some instances, a process automation framework using a machine learning-enabled natural language processing (NLP) system for processing user input provided via instructions using voice, text, and other suitable inputs and interactions may be implemented to facilitate end-to-end process execution in complex platform environments.

In some instances, the process automation framework may be used to control actions at the platform environment using different automated bots. The process automation framework may be set up to include multiple components that include logic in relation to processing input, which evaluate the received input to identify actions for execution and formulate work units that include code for execution at the platform environment to perform a valid process corresponding to the received input. The process automation framework may be configured to facilitate process automation based on input that is received in the form of a voice message or a text message, or in other forms of natural language definition used to provide a request for process execution by a user.

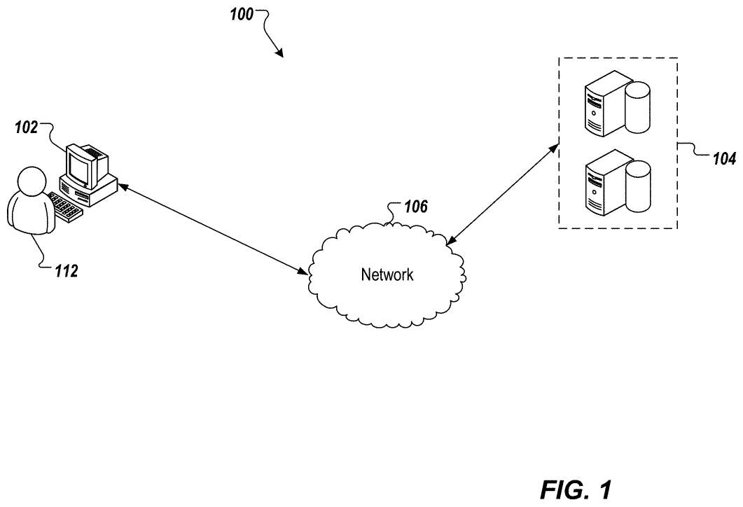

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host an enterprise platform environment where different systems are running, including cloud application, on-premise applications, application servers, application services (e.g. identity authentication services), third party software, etc. The platform environment may provide hardware and software resources for running the different systems that may be associated with different customers and different business scenarios. The running systems may require different deployment and test processed to be executed on top, for example, update or update of one or more of the application, testing and validation of the set up infrastructure and software landscape, etc. Different processes may be requested for execution by end user.

In accordance with implementations of the present disclosure, the server system 104 may host an automation framework implementing machine learning techniques for interpreting user request and generating instructions for automated process execution at the enterprise platform environment.

In some instances, a request for a process execution may be received at an input synthesizer module of the automation framework for interpreting the input and providing instructions for automatic execution of the requested process at the platform environment. The definition of the instructions for the automatic execution may be generated based on machine-learning neural network logic that may support identifying a sequence of work units of code for execution of the process. The generated sequence may be defined to validly form an end-to-end process execution that identifies necessary customer settings and configurations relevant to a received request that is provided in a natural language format.

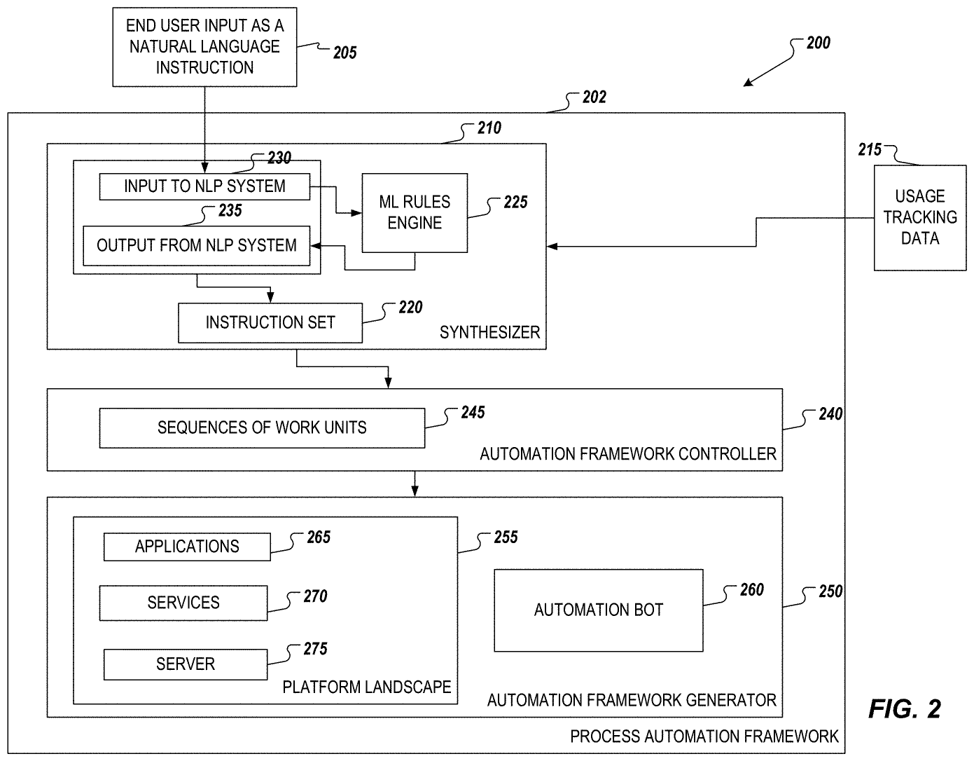

FIG. 2 is a block diagram for an example system 200 for automated execution of processes at a platform environment in accordance with implementations of the present disclosure.

The example system 200 includes a process automation framework 202 that includes a synthesizer 210, an automation framework controller 240, and an automation framework generator 250. The synthesizer 210 implements machine learning logic to interpret user input requesting a process execution into an instruction set including code for execution at a platform landscape 255.

In some instances, end user input 205 is provided to the synthesizer 210. The end user input 205 defines a request in a natural language format, the request associated with a request for a process execution at a platform environment. The end user input 205 can be received from a business user, smart test engineer, or other system user who provides input to the synthesizer 210 in relation to the platform landscape 255 using voice-enabled application or component (e.g., SLACK, SIRI, ALEXA, GOOGLE HOME, etc.) or via mobile device inputs using voice or text inputs (i.e., NLP-based inputs) to perform actions to achieve desired outputs and/or insights. Natural language processing allows for intelligent software to input as voice or natural language text from end users and convert that input into underlying software actions, as well as to train the system using machine learning rules to synthesize inputs for providing to the automation framework controller 240.

The synthesizer 210 may be a natural language processing (NLP)-enabled system that receives input and generates output 235 after the processing to determine keyword, parameter names, and parameter values of the received end user input. The synthesizer 210 includes machine learning rules that are executed by a machine learning rules engine 225 in relation to output from the NLP processing of the received end user input 205. Based on the machine learning logic implemented at the synthesizer 210, output in form of a sequence of actions for automated execution is generated. By processing the end user input 205 at the synthesizer 210, it may be determined that a particular process execution is requested for the platform landscape 255. Such a determination may be performed once the end user input 205 is parsed and keyword(s) in the input are identified that correspond to that platform landscape.

In some instances, the end user input 205 is received as input from a voice or chat application, or another form of a user application in communication with the synthesizer 210. The synthesizer 210 includes machine learning-enabled NLP implemented logic for synthesizing those inputs 230 before providing them to the automation framework controller 240. The received input 230 at the synthesizer 210 may be evaluated according to the implemented machine learning rules at the machine learning rules engine 225 to generate the output 235. In some instances, the synthesizer learns to interpret provided input and generated machine learning rules including machine learning logic to process input 230 and to generate output 235.

In some instances, the synthesizer 210 may also receive usage tracking data 215 from various usage tracking systems. The usage tracking data 215 is collected when monitoring how each component in complex enterprise environments, including the platform landscape 255, are being consumed. Such tracking data is stored and may be provided to the synthesizer 210 for further analysis and use for validation and evaluation of an instruction set for automated execution at platform landscapes part of the complex environment.

In some instances the end user input 205 is provided as voice/text inputs, e.g., through mobile applications, to an NLP-enabled system such as the synthesizer 210. The synthesizer 210 may also take as input the usage tracking data from different sources regarding usage of different systems and inputs them to the synthesizer 210 to interpret and learn to improve future usage and deployment by applying one or more machine learning rules executed by the machine-learning engine 225. Based on the logic implemented at the synthesizer 210, output 235 may be generated. Based on the output 235, an instruction set 220 may be generated that represents the output in a formatted sequence of steps for automatic execution. The instruction set 220 may be provided, for example, to an automation framework controller 240. The instruction set 220 may be provided in an XML or JSON format. The instruction set 220 may include a sequence of actions that are identified to correspond to the received end user input in form of a request. The sequence of actions may be determined based on processing the end user input 205 according to the machine learning rules to identify keywords, parameter names, and parameter values at the parsed end user input and thus to define the sequence.

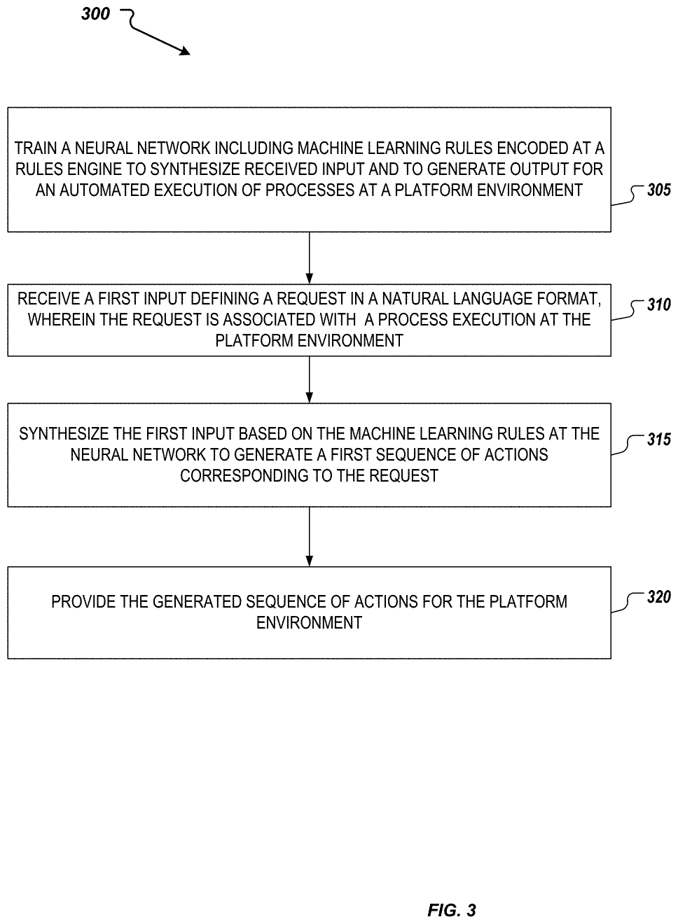

In some instances, the system of FIG. 2 including the process automation framework 250 and the included components may be configured to perform method steps as described below in relation to method 300 of FIG. 3, and additional steps as describes further in accordance with the implementations of the present disclosure.

In some instances, the synthesizer 210 may be programmed software or a suitable service which converts the end user input 205 to a sequence of actions using pre-configured keywords and associated work units. The synthesizer 210 implements machine learning logic that defines rules for creating work units for execution based on identified keywords, parameter names and parameter values at received input. The synthesizer 210 may have capabilities to understand keywords from inputs and to map those keywords to work units based on machine-learning rules and the machine-learning rules engine(s) 225. The synthesizer 210 may provide the instruction set 220 to the automation framework controller 240.

The automation framework controller 240 may accept formatted instructions and convert those instructions into actionable work-units.

In some instances, the automation framework controller 240 may capture and generate different actionable work units 245 based on the instructions at the instruction set 220. These work units 245 are sequentially parsed, and each work unit is mapped to the appropriate individual module at the platform landscape 255. The automation bot 260 is instructed and trained at the automation framework generator 250 to execute the actionable work units at corresponding system at the platform landscape 255 including application 265, services 270, and server 275. At the automation framework generator 250, the action work-units are used to generate required landscapes or workflows, as well as to train the automation bot 260. The automation bot 260 performs operation to build required landscapes or execute expected workflows to generate outcomes and/or insights to share with the user, such as the user provided input 205.

In some instances, the automation framework generator 250 communicates and generates complex landscape environments effortlessly by configuring and setting-up the platform landscape automatically based on the received end user input 205 without requiring additional user input or interaction. The different systems at the platform landscape 255 that may be affected by the execution of the automated process may be various systems and system types, such as analytics application(s) (on-premise and/or cloud), authentication services, an application server and/or web server required in system, or any other software as per landscape requirements.

Based on overall inputs, outcome from the automated execution performed at the automation framework generator 250 and by the automation bot 260 can be shared to requested users in a form of voice, text, or mail reports, based on user instructions and/or preferences.

FIG. 3 is a flowchart for an example method 300 for automated execution of processes at a platform environment in accordance with implementations of the present disclosure. In some instances, the example method 300 may be executed at the synthesizer as described in relation to the example system 200, FIG. 2.

At 305, a neural network including machine learning rules is trained to interpret received input and to generate output for use when performing automated execution of a process at a platform landscape of an enterprise including different software and hardware. The machine learning rules are encoded at a rules engine. Based on the encoded rules, a received input may be synthesized to generate output for an automated execution of processes at one or more platform landscapes. The neural network is configured to convert a received input requesting a process execution into a sequence of executable work items based on the machine learning rules.

At 310, a first input defining a request in a natural language format is received. The request is for a process execution to be performed at a platform environment. For example, the first input may be in form of a text string or a voice record provided through a chat application. The platform environment may include multiple platform landscape where different systems and applications are running.

In some instances, the received first input may be a request for an update of a particular platform landscape of a client. The platform landscape may be configured with particular client customizations and requirements that may have an impact on the execution of the update. Therefore, a generic request for an update may be related to an execution of a complex update process taking into account information for the client and the client's customization.

At 315 the first input is synthesized based on the machine learning rules at the neural network. The first input is parsed and one or more keywords may be identified that correspond to actions to be executed in relation to the received request. A first sequence of actions corresponding to the request is generated. The first sequence of actions is generated based on an evaluation of the first input in relation to the identified keywords, parameter names, and parameter values. The keywords, parameter names, and parameter values may be predefined in the neural network and included in the machine learning rules.

In some instances, the keywords, parameter names, and parameter values are encoded in the machine learning rules. When input from a user is received, such input is evaluated at the neural network based on a mapping of identified natural words to one or more of a keyword, parameter name, and a parameter value. When words from the input string are determined to correspond to a keyword, parameter name, or a parameter value, a sequence of actions is defined. For example, one keyword identified at received input may be associated with execution of two actions, in some instances with a particular order or sequence.

In one example, a machine learning rule may define a particular mapping between a first keyword, a first parameter name, and a first parameter value that define an execution of a given work unit.

In some instances, once the first input is parsed to identify a set of keywords, parameter names, and parameter values, multiple work unit for execution at the platform environment are defined. A first work unit is identified for execution at a particular platform landscape based on a particular keyword encoded as related to that particular platform landscape at the machine learning rules.

The first input may include a set of words where one or more first words correspond to a first keyword that is mapped to first work unit at the neural network logic. Further, one or more second words of the first input may correspond to a second keyword and a second corresponding work unit. The first and the second work units may be associated with a process for execution at a first platform landscape of the platform landscape. The first platform landscape may be identified by the first keyword corresponding to the first work unit.

In some instance, a particular keyword, or a combination of a keyword, parameter name, and/or a parameter value may be defined as corresponding to a particular work unit. A work unit may include a combination of instructions related to the keyword, parameter name, and/or parameter value to which it corresponds. The instructions defined in the work unit include commands that are to be executed at the platform environment to complete the request defined by the received first input. Further, the identification of a first keyword at the first input may define that two or more work units are to be executed at the platform landscape. Such a definition may be encoded at the machine learning rules.

In some instances, association between the execution of work units in relation to received keywords may be trained at the neural network and encoded in the machine learning rules. For example, the association of execution of multiple work units in relation to a single keyword may be identified based on tracking of historic interaction and requests of a particular use in relation to a given platform landscape. Tracking of interactions of users in relation to different platform landscapes and in relation to different requests with different parameters may be used to train the neural network and the encoded machine learning rules therein.

In some instances, based on the first input and parsing it to a sequence of actions, a flow for execution at a platform landscape at the platform environment is defined. The flow defines a sequence of sets of code that needs to be executed at the platform landscape. The defined sequence and/or flow of execution of commands include particular definitions of execution steps comprising details identifying components and settings from the platform landscape. Further, the sequence identifies linking between the commands, as their execution may be interrelated.

In some instances, different parameter names and parameter values may be provided to correspond to different settings for execution of the same type of a command corresponding to a keyword. Therefore, the machine learning rules may include multiple mappings of one keyword and multiple combinations of parameter names and parameter values.

In accordance with the implementations of the present disclosure and for example, if the first input includes a keyword and a parameter name, but not a parameter value, or vice versa, then such a parameter value or a parameter name may be requested to be provided by the user. In some instance, the parameter value or a parameter name may be identified by the machine learning logic based on tracked interactions stored at historic data for the landscape environment and the machine learning execution, metadata for the user providing the input, additional prediction logic encoded in the neural network, etc.

In some instances, a work unit corresponding to an action from the first sequence of action identified by synthesizing the first received input comprises work unit requirements for execution. The work unit requirements may be identified based on the identified keyword associated with the work unit and other keywords from the keywords and the machine learning rules encoded in the rules engine.

In some instances, one work unit that is identified based on the received input may be linked to another work unit, and such association between work units may be trained and encoded at the neural network and the machine learning logic.

For example, if a work unit that is identified is associated with performing a verification of a process execution, a verification may be identified as linked to a work unit for performing validation and to a second work unit for performing a report. The validation work unit may be for execution at an analytics dashboard running at the platform landscape, and the reporting work unit may be associated with providing a status report on the performed validation. For example, the association between the validation and the reporting work units may be encoded in the rules based on training data including common requests received at the neural network.

In some instances, a first sequence of actions is generated and corresponding work units including code and instructions for execution at a first platform landscape of the platform environment are identified. A first action may be identified to map to a first keyword from the received input and a parameter name and a parameter value included in the first input.

In some instances, a first work unit is identified for the first action defined for the first keyword, and a second work unit of the identified work units is identified to be related to the first work unit. The identification of the second work unit is based on encoded relationships between work units. The second work unit is identified for execution based on another work unit (here, e.g., the first work unit), and may not be specifically related to an identified keyword in the received first input.

In some instances, a sequence of instructions is provided for execution at the platform environment. The sequence of instructions may be related to a first platform landscape that is identified by one or more of the keyword determined at the first input received at the neural network. The sequence of instructions for execution may be provided to a process automation framework and in relation to different components, applications, and services running at the first platform landscape.

The first sequence of actions may define an end-to-end workflow for execution at the components at the first platform landscape. When the first sequence of actions is generated, it may be evaluated and validated whether the sequence of actions is valid.

In some instances, second input is received at the neural network that may be used for interpreting the first input and generating the sequence of action. The second input may be used when synthesizing the first input to identify details for defining the actions and the corresponding work units for execution at the platform environment. The second input may comprise tracking information for consumption of monitored components at a first platform landscape at the platform environment. Such input may also comprise other tracking information for the platform environment as a whole, and also in relation to defined account and users at the platform environment and the include platform landscapes. The first sequence of actions and the correspondingly identified work units for the received first input may be validated based on the received second input.

At 320, the generated sequence of work units are provided for automated executed by a process automation framework at the platform environment. For example, the generated sequence is provided to an automation framework controller, such as the automation framework controller 240 for providing as instructions to an automation bot and executed at systems of a first platform landscape identified based on the received input at 320.

An example workflow is provided below. Specifically, in this example a user input is received to perform automated process execution, where the user input is received in the form of a text as shown at (1):
(1) “Upgrade On-premise landscape ‘Landscape1’ to On-Premise Analytics s/w release #n+1 and validate with SAC1 (Dashboad1, if specific) and provide status.”

The process automation framework may be such as the process automation framework 202, FIG. 2, and may be a system where example method 300, FIG. 3 is executed. The process automation framework may provide services for automating process execution based on received input in a natural language format.

The user input may be received as discussed in FIG. 2 and in relation to the end user input 205 and the synthesizer 210 where the input is received, and also as discussed in relation to FIG. 3, and at a neural network trained for interpreting user input and supporting automated process execution.

In the example user input, a request for an upgrade operation is provided and details are defined in a natural language format. According to implementations of the present disclosures, the received input may be evaluated at a synthesizer, such as the synthesizer 210 of FIG. 2, and based on machine-learning logic implemented at machine learning rules at a machine learning rules engine, such as the machine learning rules engine 225 of FIG. 2.

The received input (1) may be parsed and the free-flow text can be split to identify keywords, input parameters, and parameter values, or a combination thereof.

For example, implemented machine-learning logic may be used to interpret the parsed free-flow text. The machine-learning logic may include mappings between possible keywords, parameter names, and parameter values that correspond to execution of particular work units of code for execution at an identified platform landscape.

In the example input (1), and based on evaluation according to implemented machine-learning logic and defined keyword, the following set of keywords, parameter names, and parameter values may be identified as presented in Table 1.

TABLE 1

| Keyword | Known Parameter | Values of the parameter |
|---|---|---|
| “Upgrade on-premise | Landscape 1 | ? (or unknown) |
| landscape” | | |
| “Upgrade on-premise | Release Number | N + 1 |
| landscape” | | |
| “Validate” | ? (or unknown) | CloudApplication.ver1 |
| “Provide Status” | ? (or unknown) | CloudApplication.ver1 |

In some cases, the user input might indicate a parameter name, while in some other cases, only the values. In relation to Table 1, for the areas where there is an unknown parameter name, as identified with ‘?’, the unknown parameter may be substituted with a real parameter names based on input from the user by initiating a user interaction. Alternatively, the unknown elements from such identified mappings may be predicted based on the machine learning implementation. For example, the neural network may be trained based on multiple interactions with the users for the expected parameter value or parameter name, and thus proceed with automatic execution without initiating user interaction.

From the above information and mappings in Table 1, an input synthesizer, such as synthesizer 210 of FIG. 2, may check internally to determine if it can identify the exact hardware or work unit code as mentioned by user in the user input (1). The work unit codes may be identified based on the identified keyword. For example, the input synthesizer can determine whether there is a work unit of code for ‘Upgrade’ (keyword=upgrade), whether there are any machine details available in system for ‘Landscape1’, and other similar determinations.

If no work units are available, then the end user can be notified and provided with an appropriate message. Additionally, users, such as developers can be alerted, e.g., via pre-configured emails, to provision the identified work unit as soon as possible. Over time, the machine-learning implementation can take over and build the work units based on learned behaviors and monitored actions.

If a work unit is available, then the system can proceed with building a sequence of instruction in an XML or JSON format as a string of sequences as shown in example Table 2 and Table 3 below. In this example, let it be considered that landscape “Landscape 1” is a complex distributed setup which needs user input. Additional information from the user may be needed, and can be asked as additional questions with a format of XML/JSON.

TABLE 2

<keyword>

<id>Upgrade</id>
<Workunit>

<id>UpgradeLandscape</id>
<InputParam1>TargetSystemName</InputParam1>
<InputParam2>BuildNo</InputParam2>
<InputParam3>On-premise</InputParam3>

</Workunit>

</keyword>

TABLE 3

{

“keyword”: {

“id”: “Upgrade”,
“Workunit”: {

“id”: “UpgradeLandscape”,
“InputParam1”: “TargetSystemName”,
“InputParam2”: “BuildNo”,
“InputParam3”: “On-premise”

}

}

}

Based on identified keywords, parameter names, and parameter values, a set of nodes (e.g., a set of hardware) are identified in the requested landscape (here, Landscape 1). The automated framework service may also identify install requirements using keywords and commands to be triggered for each step of the identified sequence of action based on the keyword.

In some instances, some keyword may be linked to other keyword, where linking between keyword may be defined based on user script. For example, linking between keyword is defined in Table 4 in XML, format and at Table 5 in JSON format.

TABLE 4

<keyword>

<id>Install</id>
<LinkedItems>Upgrade</LinkedItems>
<Workunit>

<id>InstallOnpremise</id>
<CommandFile>xyz.ini</CommandFile>
<Command>setup.exe -r xyz.ini</Command>

</Workunit>

</keyword>

TABLE 5

{
“keyword”: {

“id”: “Install”,
“LinkedItems”:
“Upgrade”,
“Workunit”: {

“id”: “InstallOnpremise”,
“CommandFile”: “xyz.ini”,
“Command”: “setup.exe -r xyz.ini”

}

}
}

The process automation framework may provide services to identify preset configurations, such as Secure Sockets Layer (SSL), Security Assertion Markup Language (SAML) authentication, etc., and can check if the configured system after the process execution at the platform landscape is working properly. Additionally, the process automation framework may reconfigure and confirm the system is working correctly and satisfactorily. The platform landscape and the underlying systems/application may be required to establish the connectivity with an analytics cloud based on keyword and work unit preset mapping or based on user specification. The process automation framework may need to identify all the workflows related to a platform landscape to execute an end-to-end test and qualify the landscape. Test scope can be optimized based on machine learning usage and learning. In some instances, one or more test workflows may be executed. The test workflows may be generated according to received input from usage tracking data, such as the usage tracking data 215 of FIG. 2. Status report outcomes may be provided from analytics systems.

The automation process framework described herein is intended to simplify the large-scale deployments which in effect will impact in reducing the total cost to organization (TCO) for the enterprise customer as well as the development organization. The framework may be an embedded resident solution as a part of a large scale enterprise application(s).

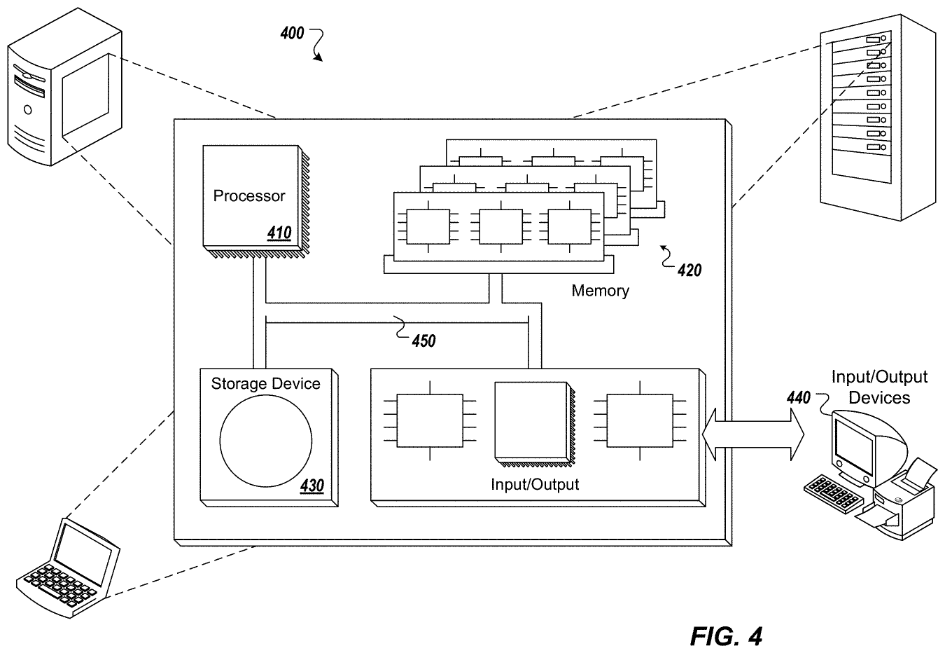

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces. The input/output device 440 may be a mobile phone and may include microphone and/or other sensor to receive voice commands.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method, the method comprising:
training a neural network including machine learning rules encoded at a rules engine to synthesize received input and to generate output for automated execution of processes at one or more platform landscapes of a platform environment, wherein the neural network is configured to convert the received input requesting a process execution into a sequence of executable work units based on the machine learning rules;
receiving a first input defining a request in a natural language format, wherein the request is associated with a process execution at the platform environment;
synthesizing the first input based on the machine learning rules at the neural network to generate a first sequence of actions corresponding to the request, wherein the first sequence of actions is generated based on an evaluation of the first input in relation to keywords, parameter names, and parameter values; and
providing the generated sequence of actions for automated execution by a process automation framework at the platform environment.

2. The method of claim 1, wherein the keywords, parameter names, and parameter values are encoded in the machine learning rules, and wherein received input at the neural network is evaluated based on a mapping of identified natural words to one or more of a keyword, parameter name, and a parameter value.

3. The method of claim 1, wherein synthesizing the first input comprises:
parsing the first input to identify keywords, parameter names, and parameter values; and
identifying a work unit for execution at a first platform landscape at the platform environment based on a keyword from the identified keywords.

4. The method of claim 3, wherein a work unit corresponding to an action from the first sequence comprises work unit requirements for execution, the work unit requirements being identified based on the identified keyword associated with the work unit and other keywords from the keywords and the machine learning rules encoded in the rules engine.

5. The method of claim 1, wherein synthesizing the first input comprises:
generating the first sequence of actions and identifying corresponding work units including code and instructions for execution at a first platform landscape, wherein a first action is identified to map to a first keyword and one or more parameter values included in the first input.

6. The method of claim 5, wherein a first work unit is identified for the first action defined for the first keyword, and wherein a second work unit of the identified work units is identified to be related to the first work unit.

7. The method of claim 5, further comprising:
receiving, at the process automation framework, a sequence of instructions for execution at a first platform landscape at the platform environment, wherein the instructions correspond to the identified work units.

8. The method of claim 1, further comprising:
receiving second input comprising tracking information for consumption of monitored components at a first platform landscape at the platform environment; and
validating the first sequence of actions and corresponding work units generated for the received first input based on the received second input, wherein the first sequence of actions defines an end-to-end workflow for execution at the components at the first platform landscape.

9. The method of claim 1, wherein a rule from the machine learning rules identifies an association between different keywords.

10. The method of claim 1, wherein the first input is in form of a text or voice input from a client application, wherein the first input include a plurality of words, wherein one or more first words of the first input correspond to a first work unit, and one or more second words of the first input correspond to a second work unit, wherein the first and the second work units are associated with a process for execution at a first platform landscape of the platform landscape, wherein the first platform landscape is identified by a first keyword corresponding to the first work unit.

11. A non-transitory, computer-readable medium coupled to one or more processors and having instructions stored thereon which, when executed by the one or more processors, cause the one or more processors to perform operations, the operations comprising:
training a neural network including machine learning rules encoded at a rules engine to synthesize received input and to generate output for automated execution of processes at one or more platform landscapes of a platform environment, wherein the neural network is configured to convert the received input requesting a process execution into a sequence of executable work units based on the machine learning rules;
receiving a first input defining a request in a natural language format, wherein the request is associated with a process execution at the platform environment;
synthesizing the first input based on the machine learning rules at the neural network to generate a first sequence of actions corresponding to the request, wherein the first sequence of actions is generated based on an evaluation of the first input in relation to keywords, parameter names, and parameter values; and
providing the generated sequence of actions for automated execution by a process automation framework at the platform environment.

12. The computer-readable medium of claim 11, wherein the keywords, parameter names, and parameter values are encoded in the machine learning rules, and wherein received input at the neural network is evaluated based on a mapping of identified natural words to one or more of a keyword, parameter name, and a parameter value, and wherein synthesizing the first input comprises:
parsing the first input to identify keywords, parameter names, and parameter values; and
identifying a work unit for execution at a first platform landscape at the platform environment based on a keyword from the identified keywords.

13. The computer-readable medium of claim 11, wherein a work unit corresponding to an action from the first sequence comprises work unit requirements for execution, the work unit requirements being identified based on the identified keyword associated with the work unit and other keywords from the keywords and the machine learning rules encoded in the rules engine.

14. The computer-readable medium of claim 11, wherein synthesizing the first input comprises:
generating the first sequence of actions and identifying corresponding work units including code and instructions for execution at a first platform landscape, wherein a first action is identified to map to a first keyword and one or more parameter values included in the first input, wherein a first work unit is identified for the first action defined for the first keyword, and wherein a second work unit of the identified work units is identified to be related to the first work unit;
receiving, at the process automation framework, a sequence of instructions for execution at a first platform landscape at the platform environment, wherein the instructions correspond to the identified work units.

15. The computer-readable medium of claim 11, wherein the operations comprise:
receiving second input comprising tracking information for consumption of monitored components at a first platform landscape at the platform environment; and
validating the first sequence of actions and corresponding work units generated for the received first input based on the received second input, wherein the first sequence of actions defines an end-to-end workflow for execution at the components at the first platform landscape.

16. The computer-readable medium of claim 11, wherein the first input is in form of a text or voice input from a client application, wherein the first input include a plurality of words, wherein one or more first words of the first input correspond to a first work unit, and one or more second words of the first input correspond to a second work unit, wherein the first and the second work units are associated with a process for execution at a first platform landscape of the platform landscape, wherein the first platform landscape is identified by a first keyword corresponding to the first work unit.

17. A system comprising
a computing device; and
a computer-readable storage device coupled to the computing device and having instructions stored thereon which, when executed by the computing device, cause the computing device to perform operations, the operations comprising:
training a neural network including machine learning rules encoded at a rules engine to synthesize received input and to generate output for automated execution of processes at one or more platform landscapes of a platform environment, wherein the neural network is configured to convert the received input requesting a process execution into a sequence of executable work units based on the machine learning rules;
receiving a first input defining a request in a natural language format, wherein the request is associated with a process execution at the platform environment;
synthesizing the first input based on the machine learning rules at the neural network to generate a first sequence of actions corresponding to the request, wherein the first sequence of actions is generated based on an evaluation of the first input in relation to keywords, parameter names, and parameter values; and
providing the generated sequence of actions for automated execution by a process automation framework at the platform environment.

18. The system of claim 17, wherein the keywords, parameter names, and parameter values are encoded in the machine learning rules, and wherein received input at the neural network is evaluated based on a mapping of identified natural words to one or more of a keyword, parameter name, and a parameter value, and wherein synthesizing the first input comprises:
parsing the first input to identify keywords, parameter names, and parameter values, and
identifying a work unit for execution at a first platform landscape at the platform environment based on a keyword from the identified keywords; and
wherein a work unit corresponding to an action from the first sequence comprises work unit requirements for execution, the work unit requirements being identified based on the identified keyword associated with the work unit and other keywords from the keywords and the machine learning rules encoded in the rules engine.

19. The system of claim 17, wherein synthesizing the first input comprises:
generating the first sequence of actions and identifying corresponding work units including code and instructions for execution at a first platform landscape, wherein a first action is identified to map to a first keyword and one or more parameter values included in the first input, wherein a first work unit is identified for the first action defined for the first keyword, and wherein a second work unit of the identified work units is identified to be related to the first work unit;
receiving, at the process automation framework, a sequence of instructions for execution at a first platform landscape at the platform environment, wherein the instructions correspond to the identified work units.

20. The system of claim 17, wherein the operations comprise:
receiving second input comprising tracking information for consumption of monitored components at a first platform landscape at the platform environment; and
validating the first sequence of actions and corresponding work units generated for the received first input based on the received second input, wherein the first sequence of actions defines an end-to-end workflow for execution at the components at the first platform landscape,
wherein the first input is in form of a text or voice input from a client application, wherein the first input include a plurality of words, wherein one or more first words of the first input correspond to a first work unit, and one or more second words of the first input correspond to a second work unit, wherein the first and the second work units are associated with a process for execution at a first platform landscape of the platform landscape, wherein the first platform landscape is identified by a first keyword corresponding to the first work unit.
